(19) United States
(12) Patent Application Publication
(10) Pub. No.: US 2019/0352155 A1
(43) Pub. Date: Nov. 21, 2019

(54) A SCISSOR JACK

(71) Applicants: Phillip James TRUTER, Pretoria (ZA); Charmain Simone TRUTER, Pretoria (ZA); Olof VORSTER, Pretoria (ZA); Rian Evert Pieter GENIS, Distrik Cullinan, (ZA); Colin CHRISTIE, Pretoria (ZA)

(72) Inventor: Colin Christie, Pretoria (ZA)

(21) Appl. No.: 16/476,218

(22) PCT Filed: Dec. 20, 2017
(86) PCT No.: PCT/IB2017/058201

§ 371 Date: Jul. 5, 2019

(30) Foreign Application Priority Data
Jan. 5, 2017 (ZA) 2017/00091

(51) Int. Cl. B66F 3/12

(52) U.S. Cl. CPC B66F 3/12

(57) ABSTRACT

The invention provides a scissor jack which includes a threaded ball screw drive shaft with a working end secured to an output connector of a planetary gearbox at the first elbow and extending through a corresponding ball screw nut assembly at a second elbow. An operating shaft is slidably engaged with and locked for rotation of an input connector of the planetary gearbox. A lock mechanism is provided to include a first mating component supported on and for rotation with the operating shaft and a second mating component fixed in relation to a housing of the planetary gearbox. The first and second mating components are provided with cooperating formations that movable into overlapping engagement to lock the operating shaft in relation to the planetary gearbox housing.

### FIELD OF THE INVENTION

The invention relates to a heavy duty scissor jack and more specifically to an operating mechanism for such a jack.

### BACKGROUND TO THE INVENTION

The lifting of heavy 4 wheel drive, off-road and specifically military vehicles to enable recovery of a “bogged down” vehicle or changing of a wheel invariably involves some difficulty. The difficulties with these lifting operations are compounded by ever increasing gross vehicle weight (GVM) weights of the vehicles that require heavy duty jacks.

The currently available jacks generally involve decades old technology, regardless of the specific mechanism, and are either not able to perform the lifting in a safe, easy, and quick manner or they leave some room for improvement in this regard.

### OBJECT OF THE INVENTION

It is an object of the current invention to provide a heavy duty scissor jack that will provide at least partially improved performance, ease of use and/or safety over current versions.

### SUMMARY OF THE INVENTION

In accordance with this invention there is provided a scissor jack comprising:
four arms hingedly arranged to provide first and second opposite elbows between a base and a load support;
a threaded ball screw drive shaft rotationally constrained at the first elbow and extending through a corresponding ball screw nut assembly at the second elbow;
a working end of the threaded drive shaft, provided adjacent the first elbow, secured to an output connector of a planetary gearbox;
an operating shaft slidably engaged with and locked for rotation of an input connector of the planetary gearbox; and
a lock mechanism which includes:
   a first mating component supported on and for rotation with the operating shaft; and
   a second mating component fixed in relation to a housing of the planetary gearbox;
with the first and second mating components having cooperating formations and movable into overlapping engagement.

The invention further provides for the first mating component to include an arrangement of pins and the second mating component to be an anchor plate located around the input connector with apertures corresponding to the pins; and for the first mating component to include a brake plate supporting the pins and fixed to the operating shaft.

A further feature of the invention provides for the pins to each have a head with an undercut section that engages over an edge of a corresponding aperture in the anchor plate.

A further feature of the invention provides for the operating shaft and the input connector to be in splined engagement.

The invention extends to a jack as defined in which the planetary gearbox is mounted onto a first faceplate of a first mounting bracket having first side plates, supported in spaced apart relationship by first cross-members, which are respectively engaged by first spigots to provide first trunnions with the first faceplate secured across the first side plates.

The invention extends to a jack as defined in which the ball screw nut assembly has a cylindrical body housed at least partly within a second mounting bracket having second side plates, supported in spaced apart relationship by second cross-members, that are respectively engaged by second spigots to provide second trunnions and a second faceplate, secured across the second side plates, against which a flange on a casing of the ball screw nut assembly is secured.

A further feature of the invention provides for the operating shaft to include a universal joint with a crank handle having a pair of rotating hand-grips to either side of the crank.

### BRIEF DESCRIPTION OF THE DRAWINGS

These and other features of the invention will become apparent from the following description of one embodiment made by way of example only with reference to the accompanying drawings, in which:

FIG. 1 shows a side view of a heavy duty scissor jack in accordance with the invention;

FIG. 2 shows a perspective view of the heavy duty scissor jack in FIG. 1;

FIG. 3 shows an exploded perspective view of planetary gearbox and brake mechanism components;

FIG. 4 shows a perspective view of a brake plate providing a first mating component supported on an operating shaft;

FIG. 5 shows an end view of an anchor plate providing a second mating component;

FIGS. 6-8 show side, cross-sectional views of an input connector secured to a sun gear and the first mating component supported on an operating shaft;

FIG. 9 shows a perspective view of the components in FIGS. 6-8 along with the second mating component and locking pins aligned with apertures;

FIG. 10 shows an end view of the components in FIG. 9;

FIG. 11 shows a perspective view of the components in FIG. 9 but with locking pins engaged in apertures;

FIG. 12 shows an end view of FIG. 11;

FIG. 13 shows a perspective view of a first mounting bracket, for the planetary gearbox;

FIG. 14 shows a perspective view of a second mounting bracket, for a ball screw nut assembly;

FIG. 15 shows an exploded perspective view of the second mounting bracket, threaded ball screw shaft, and ball screw nut assembly; and

FIG. 16 shows a perspective view of the scissor jack fitted with a crank handle.

### DETAILED DESCRIPTION OF THE INVENTION

Referring to the drawings, a heavy duty scissor jack 1 is provided with a relatively robust and safe mechanical brake mechanism 2. The brake mechanism 2 enables use of a ball screw nut assembly 3 through which a threaded ball screw drive shaft 4 is rotationally driven using a planetary gearbox 5.

The low friction characteristic of such a ball screw nut assembly 3 on a correspondingly threaded drive shaft 4 would otherwise result in retraction of an extended jack 1 under a load.

The combination of the planetary gearbox 5 and ball screw nut assembly 3 enables increased load lifting capacity and efficiency over a standard drive screw/threaded trunnion scissor jack design. The scissor jack 1 construction in accordance with the invention incorporates:
A first mounting bracket 6 having side plates 7, supported in spaced apart relationship by cross-members 8, that are respectively engaged by flanged spigots 19 to provide trunnions 24 with a faceplate 10 secured across the side plates 7. The planetary gearbox 5 is mounted onto a faceplate 10 of the first mounting bracket 6; and
A second mounting bracket 11 having side plates 12, supported in spaced apart relationship by cross-members 13, which are respectively engaged by flanged spigots 19 to provide trunnions 24 and a faceplate 15, secured across the side plates 12, against which a flange 16 on a casing 17 of the ball screw nut assembly 3 is secured. The casing 17 is provided as a cylindrical body 17 housed at least partly within the second mounting bracket 11.

The first 6 and second 11 mounting brackets are, apart from the faceplates 10 and 15, of s substantially the same construction. Each of four jack arms 21 is hingedly arranged to provide first and second opposite elbows 20 between a base 25.1 and a load support 25.2. Openings 18 in the side plates 7 and 12 receive the flanged spigot component 19 that also extends through openings at the elbows 20 of the overlapping jack arms 21. A washer component 22 is secured over outer (lower) arm flanges 23 to provide the assembled trunnions 24.

The second mounting bracket 11 provides for location of the ball screw nut assembly 3 partially within the scissor jack arms 21. To this end, a suitably sized opening 26 is provided through the faceplate 15 of the second mounting bracket 11.

The faceplate 10 of the first mounting bracket 6 has an opening 26 to accommodate the threaded ball screw drive shaft 4 which is engaged to an output connector 27 of the planetary gearbox. The brake mechanism 2 in accordance with the invention is attached to the planetary gearbox 5 and is operated manually using a crank handle 28.

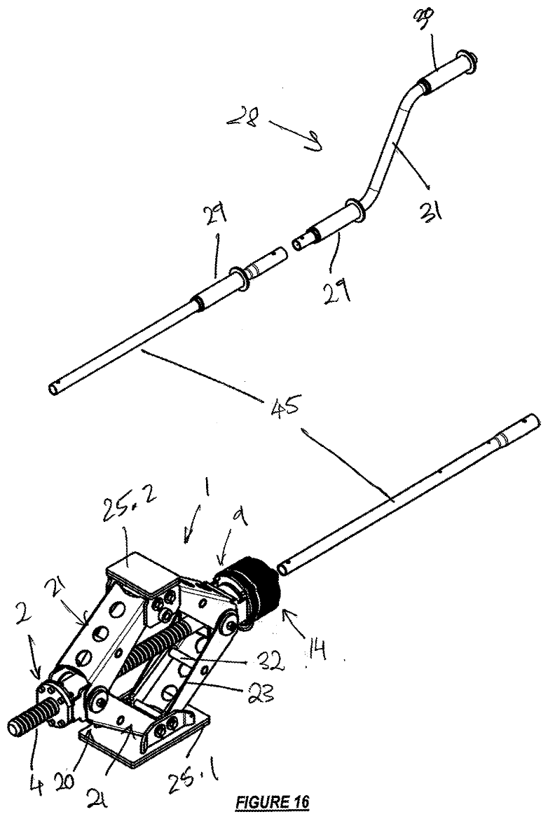

The crank handle 28 is preferably provided with a pair of rotating hand-grips 29 and 30 to either side of a crank 31. An inner (first) hand-grip 29 allows an operating shaft to be stabilized while an outer (second) hand-grip 30 rotates on a turning portion of the crank handle—the handle is shown in FIG. 16.

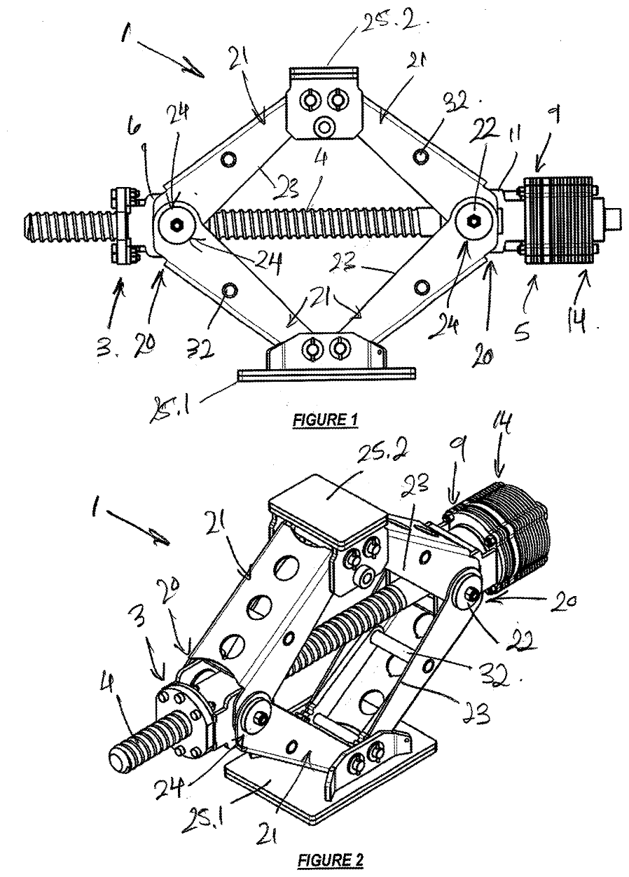

Each of the scissor jack arms 21 has a reinforcing cross-member 32 secured between the respective pairs of opposed flanges. The cross-members 32 in this embodiment are provided by tubes welded into openings part-way along between ends of the arms 21—visible as circles on the side view of the jack in FIGS. 1 and 2.

The brake mechanism 2 includes a first mating component 33 provided as a brake plate 33 fitted with locking pins (or lugs) 34 that are movable into and out of a position in overlapping engagement within the pin lock recesses (or apertures) 35 located within an anchor plate 36.

The brake plate 33 has a recessed or cut-away edge to provide four radial lobes 37. In an alternative embodiment, the brake plate 33 may be provided as a round disc.

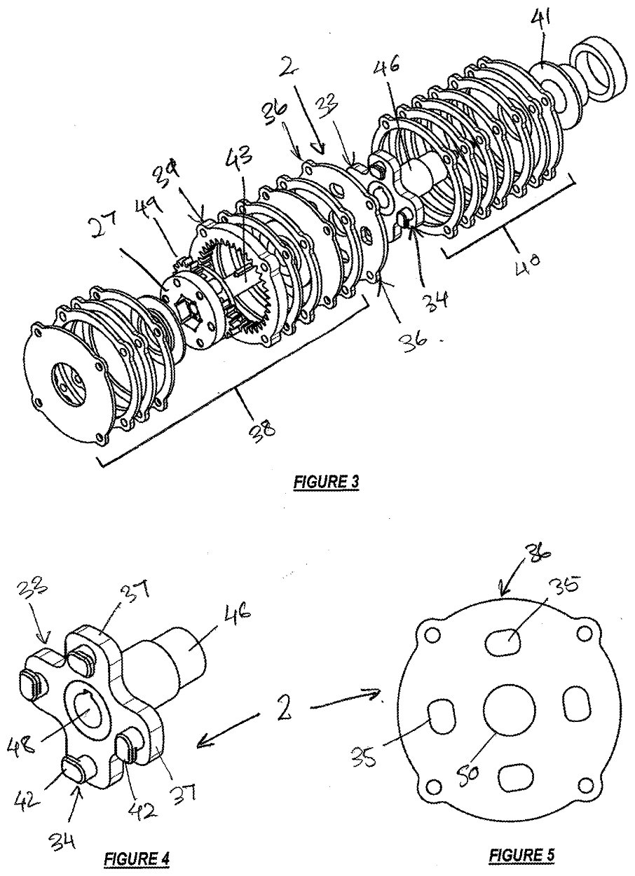

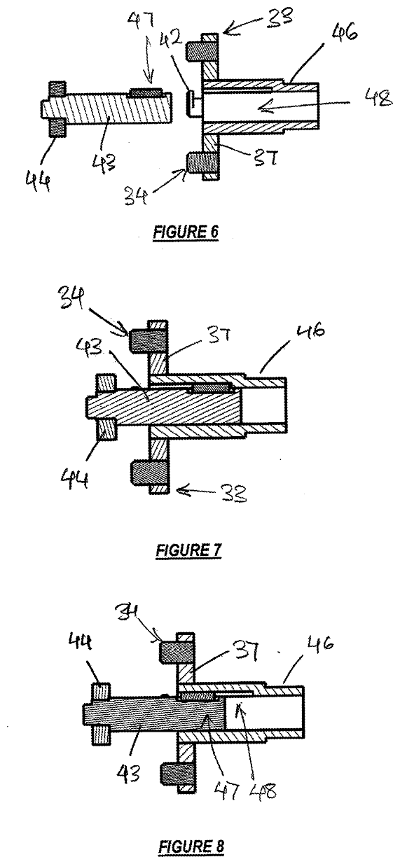

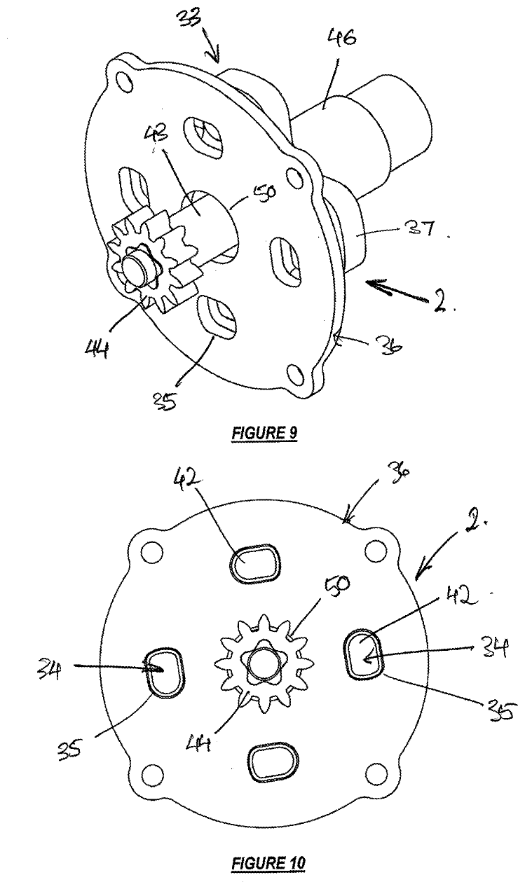

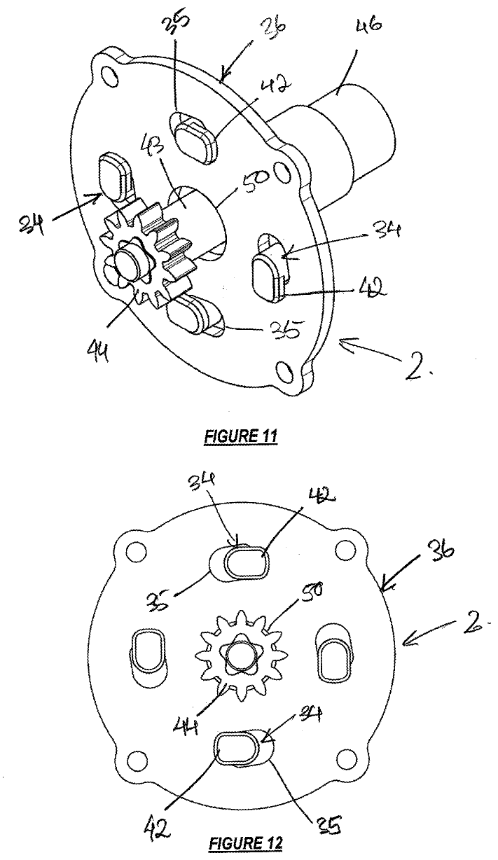

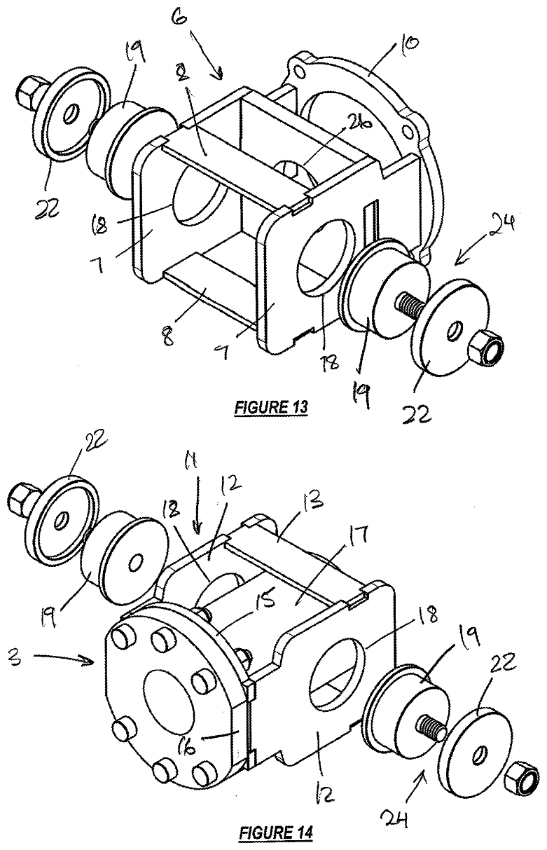

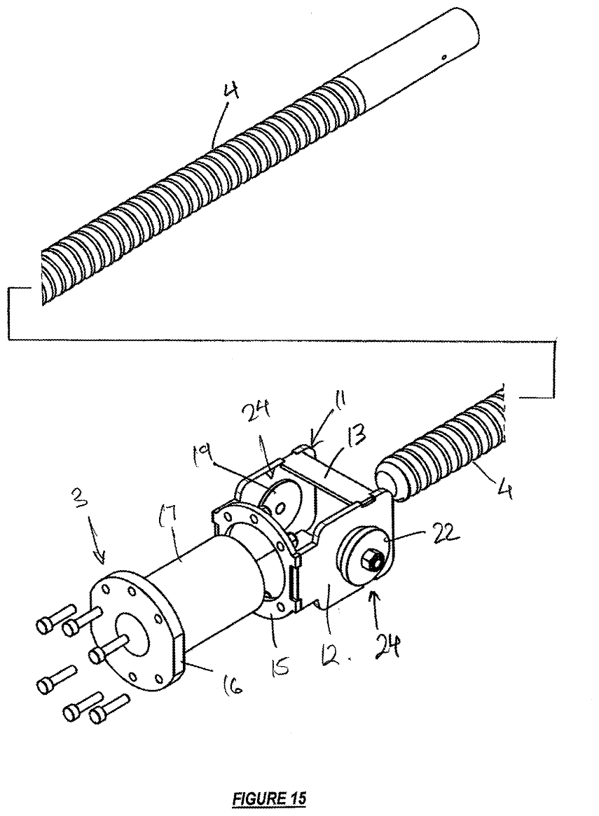

The planetary gearbox 5 has a housing 9 provided by stacked plate components 38 as illustrated in FIG. 3, which provide first spacers 38 secured together by tie bolts, with one of the spacers 38 providing a ring gear 39 and another of the spacers 38 providing the anchor plate 36.

A series of second spacers 40 stacks onto the anchor plate 36 to provide a housing 14 for the brake plate 33.

With the scissor jack 1 in the lowered position and without a load an operator places the scissor jack 1 as required in proximity of the load to be lifted. The crank handle 28 will be fitted with at least one extension 45 (two in FIG. 16) connected at the planetary gearbox 5 through a universal joint, which is in turn connected to onto an outer end of an operating shaft 46.

An input connector 43 of the planetary gearbox 5 extends through a central opening 50 in the anchor plate 36 and carries a sun gear 44. The operating shaft 46 is locked rotationally to the input connector 43 through splined spigot 47 and corresponding socket 48 mating components which enable the required longitudinal sliding connection for operation of the brake plate 33, which is fixed to the inner end of the operating shaft 46.

With a controlled movement the operator pulls crank handle 28 away from the scissor jack 1 to disengage the brake plate 33 and its locking pins 34 from the anchor plate 36 and turns the handle 28 clockwise.

The operator maintains the operating shaft 46 in the disengaged backward position with the brake plate 33 against a Nylon bush 41 to allow for the free rotational movement of the operating shaft 46 which in turn, through the splined connection, rotates the input connector 43 carrying a sun gear 44.

While maintaining a steady tension on the handle 28 with the brake plate 33 against the Nylon bush 41 the operator rotates the handle 28 with a controlled clockwise rotation to effect the simultaneous rotation of the sun gear 44, which translates to the required rotation through the sun gear 44 and planet gears 49 and to the threaded drive shaft within the ball screw nut assembly to extend the scissor jack arms 21 and lift the load support 25.

In this manner, the operator extends the scissor jack moving the load support 25 upwards and against a point of engagement on the vehicle (or other load) and commences with the lifting operation until the load is at a required elevation.

Each of the locking pins 34 includes a head 42 provided as a tongue 42. Each tongue 42 extends to a corresponding side of its pin 34 for operational, overlapping engagement of the anchor plate 36 on anti-clockwise rotation of the handle 28. Cam surfaces or inclined leading edges 43 on the ends of the locking pins 34 and tongues 42 are used to facilitate their passage into the apertures 35 of the anchor plate 36.

The ball screw assembly 3 provides a relative easy lifting process due to the low friction characteristic in operation of the threaded drive shaft 4 and the scissor jack 1 can be extended into the extended condition relatively quickly.

Once the scissor jack is adequately extended with the load in a desired position, the operator pushes the handle 28 (and thus the operating shaft 46 and brake plate 33) back towards the scissor jack 1. With the tongues on the locking pins 34 and the recesses 35 aligned, by manipulating the handle to the required position, the brake plate 33 is moved into mating engagement with the anchor plate 36 to lock the scissor jack 1 in the extended position.

The handle must then under control of the operator be permitted a small degree of anti-clockwise rotation to bring the locking pins 34 into secure engagement inside the pin locking recesses 35 of the anchor plate.

The down force of the load will turn the operating shaft anti-clockwise and bring the locking pins of the brake plate into frictional engagement with edges of the recess. The tongues on the ends of the locking pins hold the brake plate against withdrawal from the anchor plate. The universal joint is located firmly against the brake assembly housing end cap when the locked condition has been properly assumed.

It will be appreciated that the use of a head/tongue or an undercut on the locking pins 34 to engage against over the edges of the recess will facilitate the locked engagement of the jack 1 under a load and deter against unintentional release of the pins 34 from the recesses 35.

The lifted load will thus be secured and the locked scissor jack 1 can only be unlocked by the operator intentionally releasing the locked brake plate 33. While in a load supporting condition with the scissor jack under compression the locking pins 34 are constantly under load within the pin lock recesses 35 in the anchor plate 36.

To enable the release of the load compression effect on the locking pins 34 the operator turns the handle slightly clockwise for alignment of the tongues and then pulls the locking pins free from the pin lock recesses 35. With the locking pins 34 free and the brake plate 33 against the Nylon bush 31, the operator can proceed to either further lift (clockwise rotation) or lower (anti-clockwise rotation) the scissor jack load.

As with the clockwise rotation of the lifting operation, the anti-clockwise rotation of the handle 28 to lower the load must be executed under control of the operator and with the brake plate 33 and locking pins 34 withdrawn from the pin locking recesses 35 of the anchor plate 36.

Once the load support 25 is free from the load lifting point the operator can lower the scissor jack 1 into a fully withdrawn or retracted condition and lock the locking pins 34 in the pin lock recesses 35 to remove the scissor jack 1 from beneath the load.

In a development of the invention, a spring may be included which biases the brake plate 33 towards the anchor plate. Such an arrangement will move into a locked condition in the absence of an operator maintaining the required longitudinal force to overcome the bias of the spring.

The invention accordingly provides a scissor jack with heavy duty capabilities that offers, amongst others, the following advantageous features:
(a) A mechanical brake mechanism that works in conjunction with the planetary gearbox and provides for easy, hands-on, operation with effective locking of an extended jack under load and can be used conveniently by both left and right handed operators.
(b) First and second mounting brackets which enable a secure and convenient fitment of the relevant operating components and trunnions onto the scissor jack structure providing for a compact and robust construction of the articulated elbows.

The invention accordingly provides a scissor jack having heavy load lifting capabilities, structural stability, safety and ease of use with a relatively quick lifting/lowering procedure during a recovery and/or wheel replacement operation.

A person skilled in the art will appreciate that a number of changes may be made to the features of the embodiment described without departing from the scope of the invention. The first and second mating components could, for example, be provided in a variety of configurations that allow the necessary overlapping, locked engagement of the input connector and sun gear relative to the planetary gearbox housing.

1. A scissor jack comprising:
four arms hingedly arranged to provide first and second opposite elbows between a base and a load support;
a threaded ball screw drive shaft secured to an output connector of a planetary gearbox at the first elbow and extending through a corresponding ball screw nut assembly at the second elbow;
an operating shaft slidably engaged with and locked for rotation of an input connector of the planetary gearbox; and
a lock mechanism which includes:
a first mating component supported on and for rotation with the operating shaft; and
a second mating component fixed in relation to a housing of the planetary gearbox;
with the first and second mating components having cooperating formations movable into overlapping engagement.

2. A scissor jack as claimed in claim 1 in which the first mating component includes an arrangement of pins and the second mating component is provided as an anchor plate located around the input connector with apertures corresponding to the pins.

3. A scissor jack as claimed in claim 2 in which the first mating component includes a brake plate supporting the pins and fixed to the operating shaft.

4. A scissor jack as claimed in claim 2 in which the pins have a head with an undercut section that engages over an edge of a corresponding aperture in the anchor plate.

5. A scissor jack as claimed in claim 1 in which the operating shaft and the input connector are in splined engagement.

6. A scissor jack as claimed in claim 1 in which the planetary gearbox is mounted onto a first faceplate of a first mounting bracket having first side plates, supported in spaced apart relationship by first cross-members, which are respectively engaged by first spigots to provide first trunnions with the first faceplate secured across the first side plates.

7. A scissor jack as claimed in claim 1 in which the ball screw nut assembly has a cylindrical body housed at least partly within a second mounting bracket having second side plates, supported in spaced apart relationship by second cross-members, that are respectively engaged by second spigots to provide second trunnions and a second faceplate, secured across the second side plates, against which a flange on a casing of the ball screw nut assembly is secured.

8. A scissor jack as claimed in claim 1 in which the operating shaft includes a universal joint with a crank handle having a pair of rotating hand-grips to either side of the crank.
